(19) United States
(12) Patent Application Publication
(10) Pub. No.: US 2019/0322528 A1
(43) Pub. Date: Oct. 24, 2019

(54) PLASMA OZONE GENERATOR

(71) Applicant: Xinwang Liu, Hebei (CN)

(72) Inventors: Xinwang Liu, Hebei (CN); Guofa Li, Beijing (CN); Junhao Xu, Beijing (CN); Fengyan Bi, Beijing (CN); Jun Ma, Beijing (CN)

(21) Appl. No.: 15/955,962

(22) Filed: Apr. 18, 2018

(51) Int. Cl. C01B 13/11

(52) U.S. Cl. CPC C01B 13/115; C01B 2201/76; C01B 2201/12; C01B 2201/22; C01B 2201/64

(57) ABSTRACT

A plasma ozone generator includes a discharge unit assembly, a high-voltage electrode bar assembly, an oxygen pipeline assembly, an ozone pipeline assembly, a cooling water inlet pipeline assembly, and a cooling water return pipeline assembly. By using the plasma ozone generator of the present disclosure, performance indicators such as a small volume, a high yield, small concentration decay, low power consumption, easy maintenance, and modularization are achieved, and an explosion-proof function and a flame-retardant function are generally provided, thereby achieving a safer and more reliable effect.

### TECHNICAL FIELD

The present disclosure relates to ozone production, and, in particular, to a plasma ozone generator.

### BACKGROUND

Low temperature plasma technology has been used to produce ozone for a hundred years. With the development of technology, a dielectric barrier discharge (DBD) ozone generator that has emerged in recent years is a breakthrough in theory and practice.

With the increasingly urgent need of atmospheric pollution control and water pollution control, many types of environmental protection technologies and equipment are needed to control the pollution of the atmospheric environment and water environment. Ozone has been used widely as a strong oxidizing agent that does not cause secondary pollution. Performance indicators of ozone generators need to be further increased, and the structural designs and processes of generators need to be continuously improved. There is an urgent need for ozone generators that can operate at low costs and have high performance, high stability, high reliability, and high safety.

Ozone generators are structurally classified into tube-type ozone generators and plate-type ozone generators. Electrode processing for tube-type ozone generators has disadvantages that consumption of materials is high, and it is difficult to improve processing precision, which restricts the development of ozone products. In conventional industrial tube-type ozone generators, a ground electrode has a honeycomb structure, and includes a cylindrical container, a tubular electrode, and a porous flange. The cylindrical container has caps at the ends and is filled with cooling water. A tubular electrode and a cylindrical container of an existing tube-type ozone generator are integrated by welding. Large deformations occur during welding, assembly is difficult, and repair is not easy. Existing plate-type ozone generators have problems such as inclusion of many joints and seals, inappropriate layout of cooling water, and many parts and components.

Thus, it would be desirable to improve upon the conventional designs of ozone generators, to address these and other concerns.

### SUMMARY

The present disclosure provides a plasma ozone generator that achieves performance indicators such as a small volume, a high yield, small concentration decay, low power consumption, easy maintenance, and modularization and generally has a designed explosion-proof function and a flame-retardant function, thereby achieving a safer and more reliable operation.

A plasma ozone generator according to one embodiment of the invention includes a discharge unit assembly, a high-voltage electrode bar assembly, an oxygen pipeline assembly, an ozone pipeline assembly, a cooling water inlet pipeline assembly, and a cooling water return pipeline assembly. The discharge unit assembly is configured to produce a corona discharge. The high-voltage electrode bar assembly is connected to the discharge unit assembly, and is configured to feed a high-voltage current. The oxygen pipeline assembly is connected to an inlet of the discharge unit assembly, and is configured to feed oxygen. The ozone pipeline assembly is connected to an outlet of the discharge unit assembly, and is configured to emit ozone. The cooling water inlet pipeline assembly, a cooling water channel in the discharge unit assembly, and the cooling water return pipeline assembly are connected in sequence, to cool the discharge unit assembly.

In one aspect, the plasma ozone generator further includes a front generator support assembly and a rear generator support assembly. The front generator support assembly and the rear generator support assembly are used to fix the discharge unit assembly, the high-voltage electrode bar assembly, the oxygen pipeline assembly, the ozone pipeline assembly, the cooling water inlet pipeline assembly, and the cooling water return pipeline assembly.

In another aspect, the discharge unit assembly further includes eight independent discharge channel modules, and each discharge channel module comprises an integrated ground electrode module unit, a precision positioning tube, and a composite high-voltage electrode dielectric plate.

In a further aspect, the high-voltage electrode bar assembly further includes a high-voltage sealed busbar, a high-voltage fuse component, a fixing clamp, and a high-voltage fixed box. The high-voltage sealed busbar uses the process of distributed trunking and shunting, and is configured to feed a high-voltage current into discharge units. The high-voltage fuse component is equipped with a high-voltage fuse; the fixing clamp is configured to fix the position of a fuse; and the high-voltage fixed box is configured to accommodate the high-voltage sealed busbar, the high-voltage fuse component, and the fixing clamp in a sealed manner.

In some embodiments, the oxygen pipeline assembly further includes an oxygen manifold, an oxygen manifold plug, an oxygen manifold fitting, and a compression fitting. A threaded o-shaped rubber ring (also referred to as an O-ring) is used for sealing. The material of the oxygen manifold is aluminum alloy. A protruding step is disposed for position limiting and uniform hole distribution. The oxygen manifold is connected to inlets of discharge units through the compression fitting with a PTFE hose in the middle.

In other embodiments, the ozone pipeline assembly further includes an ozone manifold, an ozone manifold plug, an ozone manifold fitting, and a compression fitting. A threaded o-shaped rubber ring is used for sealing. The material of the ozone manifold is aluminum alloy. A protruding step is disposed for position limiting and uniform hole distribution. The ozone manifold is connected to outlets of discharge units through the compression fitting with a PTFE hose in the middle.

In one aspect, the cooling water inlet pipeline assembly further includes a cooling water inlet pipe, a cooling water pipe quick fitting, a cooling water pipe plug, a cooling water pipeline quick ⅜-inch fitting, and a high-temperature-resistant cooling water hose. An O-ring and a compression member are used for sealing, a projecting portion is provided on the cooling water inlet pipe for positioning and uniform hole distribution, and each cooling water inlet pipe corresponds to one discharge channel module.

In another aspect, the cooling water return pipeline assembly further includes a cooling water return pipe, a cooling water pipe quick fitting, a cooling water pipe plug, a cooling water pipeline quick ⅜-inch fitting, and a high-temperature-resistant cooling water hose. An O-ring and a compression member are used for sealing, a projecting portion is provided on the cooling water return pipe for positioning and uniform hole distribution, and each cooling water return pipe corresponds to one discharge channel module.

In a further aspect, the front generator support assembly further includes a support piece, a support piece cover plate, and a V-pulley set. The V-pulley set is used together with a guide rail, and the material of the front generator support assembly is semi-open, U-shaped aluminum alloy.

In yet another aspect, the rear generator support assembly further includes a support piece, a support piece cover plate, and a V-pulley set. The V-pulley set is used together with a guide rail, and the material of the rear generator support assembly is semi-open, U-shaped aluminum alloy.

By using the ozone generator as described herein, the problems that occur during the operation of conventional tube-type ozone generators and some plate-type ozone generators are overcome, and performance indicators such as low energy consumption, high stability, high reliability, high safety, a small volume, easy maintenance, and modularization in practical application are achieved.

The technical solution of the present disclosure is further described below in detail with reference to the accompanying drawings and embodiments.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, explain the one or more embodiments of the invention.

FIG. 1 is a front view of a plasma ozone generator in one embodiment of the invention.

FIG. 2 is a side view of the plasma ozone generator of FIG. 1.

FIG. 3 is a front view of a high-voltage electrode bar assembly used with the plasma ozone generator of FIG. 1.

FIG. 4 is a top view of a high-voltage fixed box in the high-voltage electrode bar assembly of FIG. 3.

FIG. 5 is a top view of an oxygen pipeline assembly and an ozone pipeline assembly used with the plasma ozone generator of FIG. 1.

FIG. 6 is a top view of a cooling water inlet pipeline assembly used with the plasma ozone generator of FIG. 1.

FIG. 7 is a top view of a cooling water return pipeline assembly used with the plasma ozone generator of FIG. 1.

### DETAILED DESCRIPTION

Embodiments of the invention are illustrated below with reference to the accompanying drawings. The preferred embodiments described here are used only to describe and explain the present disclosure, but not to limit the present disclosure.

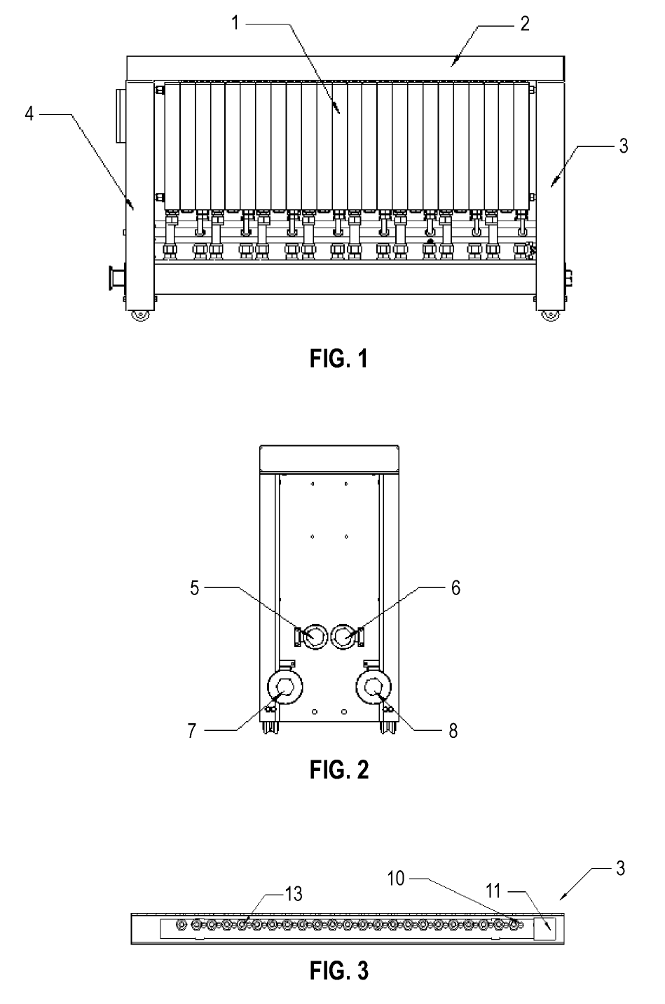

FIG. 1 is a structural view of a plasma ozone generator in one embodiment of the present disclosure. FIG. 2 is a structural side view of the plasma ozone generator. As shown in FIG. 1 and FIG. 2, the plasma ozone generator is a modular plate-type plasma ozone generator, including a discharge unit assembly 1, a high-voltage electrode bar assembly 2, a front generator support assembly 3, a rear generator support assembly 4, an oxygen pipeline assembly 5, an ozone pipeline assembly 6, a cooling water inlet pipeline assembly 7, and a cooling water return pipeline assembly 8.

The discharge unit assembly 1 is configured to produce a corona discharge. The high-voltage electrode bar assembly 2 is connected to the discharge unit assembly 1 and is configured to feed a high-voltage current. The oxygen pipeline assembly 5 is connected to an inlet of the discharge unit assembly 1 and is configured to feed oxygen. The ozone pipeline assembly 6 is connected to an outlet of the discharge unit assembly 1 and is configured to emit ozone. The cooling water inlet pipeline assembly 7, a cooling water channel in the discharge unit assembly 1, and the cooling water return pipeline assembly 8 are connected in sequence, to cool the discharge unit assembly 1. The front generator support assembly 3 and the rear generator support assembly 4 are used to fix the discharge unit assembly 1, the high-voltage electrode bar assembly 2, the oxygen pipeline assembly 5, the ozone pipeline assembly 6, the cooling water inlet pipeline assembly 7, and the cooling water return pipeline assembly 8.

The assembly sequence is as follows: The discharge unit assembly 1 is mounted first, which is completed by using special hydraulic tooling during the mounting. The front generator support assembly 3 and the rear generator support assembly 4 are then mounted and fixed together with the discharge unit assembly 1. The oxygen pipeline assembly 5 and the ozone pipeline assembly 6 are then mounted in the position shown in FIG. 1. The cooling water inlet pipeline assembly 7 and the cooling water return pipeline assembly 8 are then mounted in the position shown in FIG. 1. Eventually, the high-voltage electrode bar assembly 2 is fixed to the top of the plasma ozone generator.

The discharge unit assembly 1 further forms eight independent discharge channel modules. Each discharge channel module includes an integrated ground electrode module unit, a precision positioning tube, and a composite high-voltage electrode dielectric plate.

Twenty-three discharge units are the core critical components of the entire plasma ozone generator. The corona discharge is completed inside the discharge unit assembly 1. The twenty-three discharge units are grouped into eight independent discharge channel modules, gas paths for each independent discharge channel module are connected in series internally, and ozone then converges in an ozone manifold through a gas path seal fitting. In this way, all internal gas paths are completed within the discharge units. Moreover, for seals, a multi-ring seal is used, and the number for seal joints is small, so that no ozone leaks, and a sealing problem of plate-type ozone generators is completely solved.

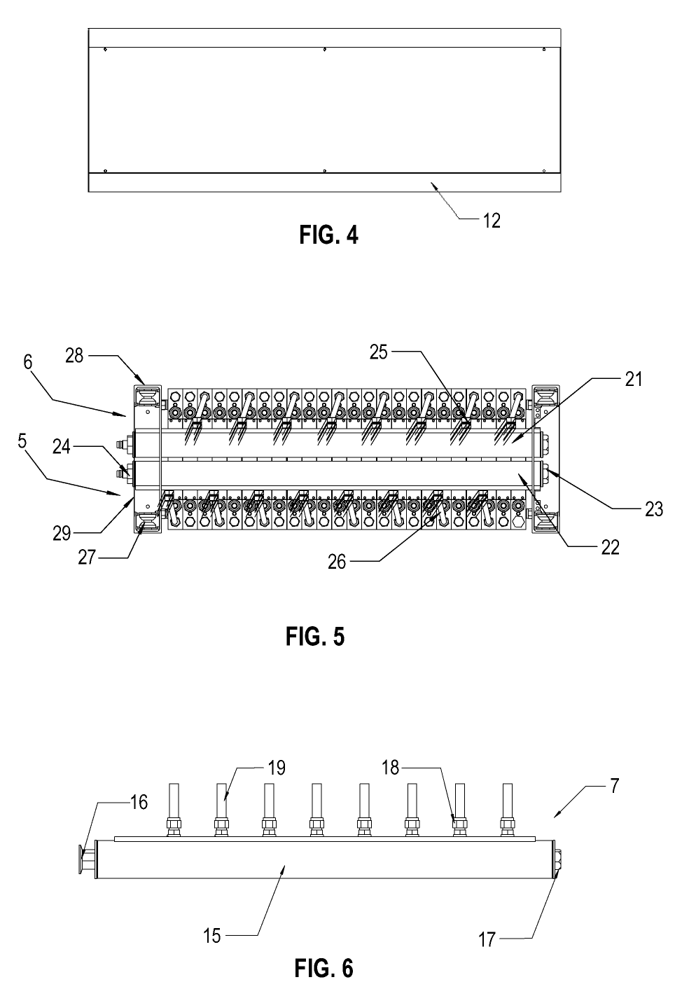

FIG. 3 is a structural front view of the high-voltage electrode bar assembly 2 in the embodiment of the present disclosure. FIG. 4 is a top view of a high-voltage fixed box 12 in the high-voltage electrode bar assembly 2 in the embodiment of the present disclosure. As shown in FIG. 3 and FIG. 4, the high-voltage electrode bar assembly 2 further includes a high-voltage sealed busbar 11, a high-voltage fuse component 10, a fixing clamp 13, and a high-voltage fixed box 12.

The high-voltage sealed busbar 11 uses the process of distributed trunking and shunting and is configured to feed a high-voltage current into discharge units. The high-voltage fuse component 10 is equipped with a high-voltage fuse. The fixing clamp 13 is configured to fix the position of a fuse. The high-voltage fixed box 12 is configured to accommodate the high-voltage sealed busbar 11, the high-voltage fuse component 10, and the fixing clamp 13 in a sealed manner.

The high-voltage sealed busbar 11 uses the process of distributed trunking and shunting and is configured to feed a high-voltage current into the twenty-three discharge units separately through the high-voltage sealed busbar 11, and has functions such as high voltage resistance, insulation, water resistance, real-time displaying of a working status of a generator, and the like. There are twenty-three groups of high-voltage fuse components in total, with a high-voltage fuse provided inside. When discharge units are short circuited, the high-voltage fuse is immediately blown, so that the normal operation of the plasma ozone generator is not affected. The high-voltage fixed box 12 is configured to accommodate the high-voltage sealed busbar 11, the high-voltage fuse components 10, the fixing clamp 13, a current acquisition and display component, and the like, and a cover plate is then used to seal all the high-voltage parts.

The high-voltage sealed busbar 11 has openings for uniform flowing. An insulating, sealed material is injected for sealing. The high-voltage fuse components 10 are arranged uniformly. A high-voltage current can be cut off when discharge units are short circuited, so that the normal operation of the plasma ozone generator is not affected. Therefore, the plasma ozone generator can work continuously and stably without interruption.

FIG. 5 is a structural view of the oxygen pipeline assembly 5 and the ozone pipeline assembly 6 in the embodiment of the present disclosure. As shown in FIG. 5, the oxygen pipeline assembly 5 further includes an oxygen manifold 22, an oxygen manifold plug 23, and an oxygen manifold fitting 24. A threaded o-shaped rubber ring is used for sealing. The material of the oxygen manifold 22 is aluminum alloy. The surface of the oxygen manifold 22 has a function of resistance to corrosion by ozone. A protruding step is disposed for position limiting and uniform hole distribution, to achieve the design of uniform flowing. The oxygen manifold 22 is connected to oxygen inlets of the twenty-three discharge units through a compression fitting 25 with a PTFE hose 26 in the middle and has an explosion-proof function.

The ozone pipeline assembly 6 is like the oxygen pipeline assembly 5, and further includes an ozone manifold 21, an ozone manifold plug, and an ozone manifold fitting. A threaded o-shaped rubber ring is used for sealing. The material of the ozone manifold 21 is aluminum alloy. The surface of the ozone manifold 21 has a function of resistance to corrosion by ozone. A protruding step is disposed for position limiting and uniform hole distribution, to achieve the design of uniform flowing. The ozone manifold 21 is connected to oxygen outlets of the twenty-three discharge units through a compression fitting 25 with a PTFE hose 26 in the middle and has an explosion-proof function.

FIG. 6 is a structural view of the cooling water inlet pipeline assembly 7 in the embodiment of the present disclosure. As shown in FIG. 6, the cooling water inlet pipeline assembly 7 further includes a cooling water inlet pipe 15, a cooling water pipe quick fitting 16, a cooling water pipe plug 17, a cooling water pipeline quick ⅜-inch fitting 18, and a high-temperature-resistant cooling water hose 19. An O-ring and a compression member are used for sealing, a projecting portion is provided on the cooling water inlet pipe 15 for positioning and uniform hole distribution, and each cooling water inlet pipe 15 corresponds to one discharge channel module.

A projecting portion of the cooling water inlet pipe 15 is provided for positioning and uniform hole distribution, so that all outlets have a same flow velocity and flow rate. An aluminum-magnesium-titanium alloy material is used, and anti-corrosion treatment is performed on the surface of the material. A water pipeline joint is sealed with a threaded O-ring, to achieve efficient sealing and at the same time facilitate future maintenance. A finite element analysis design of uniform pressure and a uniform flow rate is used for eight pairs of cooling water inlets and outlets, so that it can be ensured that all outlets have a same flow rate and flow velocity, and a desirable cooling effect is achieved after the cooling water inlets and outlets are connected to cooling water channels in twenty-three groups of discharge units. One pair of cooling water inlet and outlet corresponds to three groups of discharge units, and an external joint of a cooling water pipeline uses a fast clamp connection.

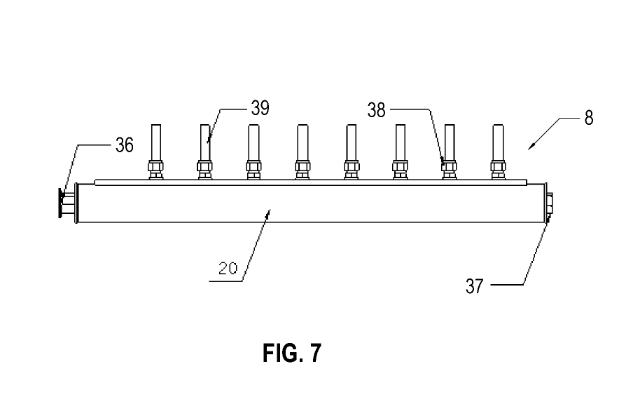

FIG. 7 is a structural view of a cooling water return pipeline assembly 8 in the embodiment of the present disclosure. As shown in FIG. 7, the cooling water return pipeline assembly 8 is like the cooling water inlet pipeline assembly 7, and further includes a cooling water return pipe 20, a cooling water pipe quick fitting 36, a cooling water pipe plug 37, a cooling water pipeline quick ⅜-inch fitting 38, and a high-temperature-resistant cooling water hose 39. An O-ring and a compression member are used for sealing, a projecting portion is provided on the cooling water return pipe for positioning and uniform hole distribution, and each cooling water return pipe corresponds to one discharge channel module.

A projecting portion of the cooling water return pipe 20 is provided for positioning and uniform hole distribution, so that all outlets have a same flow velocity and flow rate. An aluminum-magnesium-titanium alloy material is used, and anti-corrosion treatment is performed on the surface of the material. A water pipeline joint is sealed with a threaded O-ring, to achieve efficient sealing and at the same time facilitate future maintenance. A finite element analysis design of uniform pressure and a uniform flow rate is used for eight pairs of cooling water inlets and outlets, so that it can be ensured that all outlets have a same flow rate and flow velocity, and a desirable cooling effect is achieved after the cooling water inlets and outlets are connected to cooling water channels in twenty-three groups of discharge units. One pair of cooling water inlet and outlet corresponds to three groups of discharge units, and an external joint of a cooling water pipeline uses a fast clamp connection.

Returning with reference to FIG. 5, the front generator support assembly 3 further includes a support piece 28, a support piece cover plate 29, and a V-pulley set 27. The V-pulley set 27 is used together with a guide rail, and the material of the front generator support assembly 3 is semi-open, U-shaped aluminum alloy.

The rear generator support assembly 4 is like the front generator support assembly 3, and further includes a support piece, a support piece cover plate, and a V-pulley set. The V-pulley set is used together with a guide rail, and the material of the rear generator support assembly 4 is semi-open, U-shaped aluminum alloy.

The front generator support assembly 3 and the rear generator support assembly 4 are used to fix the discharge unit assembly 1, the high-voltage electrode bar assembly 2, the oxygen pipeline assembly 5, the ozone pipeline assembly 6, the cooling water inlet pipeline assembly 7, and the cooling water return pipeline assembly 8 in position. With the function of pulley rolling, the front generator support assembly 3 and the rear generator support assembly 4 cooperate with a guide rail of the plasma ozone generator, to achieve easy movement, to achieve the effect of convenient mounting and repair. Meanwhile, the front generator support assembly 3 and the rear generator support assembly 4 use semi-open, U-shaped aluminum alloy as the material, and special anti-corrosion treatment is performed on the surface.

The discharge unit assembly 1 is formed by superimposing the precision positioning tube and the integrated ground electrode module unit in parallel. The high-voltage sealed busbar 11 of the high-voltage electrode bar assembly 2 is sealed through a dedicated high-voltage fixed box 12, which can achieve uniform shunting and withstand a high voltage. The oxygen pipeline assembly 5 uniformly delivers oxygen to the discharge units. The ozone pipeline assembly 6 enables generated ozone to converge into a manifold. The cooling water inlet pipeline assembly 7 uniformly delivers cooling water to cooling water channels in the integrated ground electrode module unit. The cooling water return pipeline assembly 8 enables cooling water to return and converge and then enter a return manifold. The front generator support assembly 3 and the rear generator support assembly 4 fix the plasma ozone generator, the high-voltage electrode bar assembly 2, and the like. The centralized symmetric layout of a water path manifold and a gas path manifold of the entire plasma ozone generator is shown in FIG. 2. The oxygen pipeline assembly 5 and the ozone pipeline assembly 6 are arranged to be symmetrical in the upper part, and the cooling water inlet pipeline assembly 7 and the cooling water return pipeline assembly 8 are arranged to be symmetrical in the lower part. Therefore, the overall layout of the generator is compact, the generator has a small volume, and cooling water can reduce the temperature of oxygen in an oxygen pipe. A multi-ring sealing technology, a method of reducing ozone joints, and other methods are used in the entire plasma ozone generator, so that reliable and stable sealing are ensured.

The key operational parameters of the plasma ozone generator according to this embodiment are as follows:

| | | |
|---|---|---|
| 1 | Adjustment range of ozone generation | 0-110 |
| | amount (%) | |
| 2 | Adjustment range of ozone generation | 0-300 |
| | concentration (g/Nm3) | |
| 3 | Operating pressure (MPa) | 0.1~0.2 |
| 4 | Gas pressure at a gas outlet (MPa) | ≥0.1 |
| 5 | Power consumption of an ozone generator | ≤7.0 (10 wt %, 25° C.) |
| | per kilogram (kWh/kg · O3) | |
| 6 | Flow rate of cooling water required for | 2 |
| | each kilogram of ozone (m3/h) | |
| 7 | Inlet temperature of cooling water | ≤30 |
| | (max. C.) | |
| 8 | Outlet temperature of cooling water | 32~33 |
| | (C.) | |
| 9 | Pressure of cooling water (MPa) | 0.15~0.2 |
| 10 | Operating frequency (kHz) | 8~10 |
| 11 | Discharging gap (mm) | ≤0.2 |
| 12 | Yield range of a single modular ozone | 2~3 |
| | generator (kg/h) | |

By using the plasma ozone generator of the present disclosure, the problems that occur during the operation of tube-type ozone generators and some plate-type ozone generators are overcome, and performance indicators such as low energy consumption, high stability, high reliability, high safety, a small volume, easy maintenance, and modularization in practical application are achieved.

It should be understood by those skilled in the art that the embodiments of the present disclosure may be provided as methods, systems, or computer program products. Therefore, the present disclosure can be used in the form of complete hardware embodiments, complete software embodiments, or embodiments that combine software and hardware. Moreover, the present disclosure can be used in the form of a computer program product implemented on one or more computer available storage media (including but not limited to disk storage and optical memory) including computer available program codes.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the contents of this specification shall not be construed as a limitation to the invention.

What is claimed is:

1. A plasma ozone generator, comprising:
a discharge unit assembly,
a high-voltage electrode bar assembly,
an oxygen pipeline assembly,
an ozone pipeline assembly,
a cooling water inlet pipeline assembly, and
a cooling water return pipeline assembly,
wherein the discharge unit assembly is configured to produce a corona discharge;
wherein the high-voltage electrode bar assembly is connected to the discharge unit assembly and is configured to feed a high-voltage current;
wherein the oxygen pipeline assembly is connected to an inlet of the discharge unit assembly and is configured to feed oxygen;
wherein the ozone pipeline assembly is connected to an outlet of the discharge unit assembly and is configured to emit ozone; and
wherein the cooling water inlet pipeline assembly, a cooling water channel in the discharge unit assembly, and the cooling water return pipeline assembly are connected in sequence, to cool the discharge unit assembly.

2. The plasma ozone generator of claim 1, further comprising:
a front generator support assembly; and
a rear generator support assembly,
wherein the front generator support assembly and the rear generator support assembly are used to fix the discharge unit assembly, the high-voltage electrode bar assembly, the oxygen pipeline assembly, the ozone pipeline assembly, the cooling water inlet pipeline assembly, and the cooling water return pipeline assembly in position.

3. The plasma ozone generator of claim 1, wherein the discharge unit assembly further comprises:
eight independent discharge channel modules, and each discharge channel module comprises an integrated ground electrode module unit, a precision positioning tube, and a composite high-voltage electrode dielectric plate.

4. The plasma ozone generator of claim 3, wherein the high-voltage electrode bar assembly further comprises:
a high-voltage sealed busbar,
a high-voltage fuse component,
a fixing clamp, and
a high-voltage fixed box;
wherein the high-voltage sealed busbar uses a process of distributed trunking and shunting and is configured to feed a high-voltage current into discharge units;
wherein the high-voltage fuse component is equipped with a high-voltage fuse;
wherein the fixing clamp is configured to fix a position of a fuse; and
wherein the high-voltage fixed box is configured to accommodate the high-voltage sealed busbar, the high-voltage fuse component, and the fixing clamp in a sealed manner.

5. The plasma ozone generator of claim 1, wherein the oxygen pipeline assembly further comprises an oxygen manifold, an oxygen manifold plug, an oxygen manifold fitting, and a compression fitting,
wherein a threaded o-shaped rubber ring is used for sealing, the oxygen manifold is formed from aluminum alloy, a protruding step is disposed for position limiting and uniform hole distribution, and the oxygen manifold is connected to inlets of discharge units through the compression fitting with a PTFE hose.

6. The plasma ozone generator of claim 1, wherein the ozone pipeline assembly further comprises an ozone manifold, an ozone manifold plug, an ozone manifold fitting, and a compression fitting,
wherein a threaded o-shaped rubber ring is used for sealing, the ozone manifold is formed from aluminum alloy, a protruding step is disposed for position limiting and uniform hole distribution, and the ozone manifold is connected to outlets of discharge units the compression fitting with a PTFE hose.

7. The plasma ozone generator of claim 3, wherein the cooling water inlet pipeline assembly further comprises a cooling water inlet pipe, a cooling water pipe quick fitting, a cooling water pipe plug, a cooling water pipeline quick ⅜-inch fitting, and a high-temperature-resistant cooling water hose,
wherein an O-ring and a compression member are used for sealing,
wherein a projecting portion is provided on the cooling water inlet pipe for positioning and uniform hole distribution, and
wherein each cooling water inlet pipe corresponds to one discharge channel module.

8. The plasma ozone generator of claim 3, wherein the cooling water return pipeline assembly further comprises a cooling water return pipe, a cooling water pipe quick fitting, a cooling water pipe plug, a cooling water pipeline quick ⅜-inch fitting, and a high-temperature-resistant cooling water hose,
wherein an O-ring and a compression member are used for sealing,
wherein a projecting portion is provided on the cooling water return pipe for positioning and uniform hole distribution, and
wherein each cooling water return pipe corresponds to one discharge channel module.

9. The plasma ozone generator of claim 2, wherein the front generator support assembly further comprises a support piece, a support piece cover plate, and a V-pulley set,
wherein the V-pulley set is used together with a guide rail, and the front generator support assembly is formed from semi-open, U-shaped aluminum alloy.

10. The plasma ozone generator of claim 2, wherein the rear generator support assembly further comprises a support piece, a support piece cover plate, and a V-pulley set,
wherein the V-pulley set is used together with a guide rail, and the rear generator support assembly is formed from semi-open, U-shaped aluminum alloy.
